(19) United States
(12) Patent Application Publication
(10) Pub. No.: US 2014/0315555 A1
(43) Pub. Date: Oct. 23, 2014

(54) ADAPTIVE CELL RESELECTION

(71) Applicant: QUALCOMM INCORPORATED, San Diego, CA (US)

(72) Inventors: Wei Zhang, San Diego, CA (US); Tom Chin, San Diego, CA (US)

(73) Assignee: QUALCOMM Incorporated, San Diego, CA (US)

(21) Appl. No.: 13/866,591

(22) Filed: Apr. 19, 2013

(51) Int. Cl. H04W 36/00; H04W 52/02

(52) U.S. Cl. CPC H04W 36/0094; H04W 52/0245
USPC 455/437; 455/552.1; 455/574

(57) ABSTRACT

Idle power consumption of a user equipment (UE) is affected by an adaptive cell reselection process to prevent ping-pong cell reselection. The adaptive cell reselection includes adapting triggering threshold values for reselection based on signal strengths. The triggering threshold value may be increased for cell reselection while the UE receives a good signal from a serving cell. When the serving cell signal is poor, the cell reselection triggering threshold value is decreased to allow for fast cell reselection.

### BACKGROUND

1. Field

Aspects of the present disclosure relate generally to wireless communication systems, and more particularly, to improving UE idle power performance in a wireless network, such as a Time Division-Synchronous Code Division Multiple Access (TD-SCDMA) network.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication includes increasing a triggering threshold value for cell reselection when a plurality of neighbor cell signal strengths are each within a predefined range of a serving cell signal strength, and the serving cell signal strength is above a first predefined threshold value.

According to one aspect of the present disclosure, a method for wireless communication includes triggering inter-radio access technology (IRAT) cell reselection only when both a signal quality of a serving cell and a signal quality of a neighbor cell are below a threshold value, the neighbor cell and the serving cell being of the same RAT.

According to another aspect of the present disclosure, an apparatus for wireless communication includes means for increasing a triggering threshold value for cell reselection when a plurality of neighbor cell signal strengths are each within a predefined range of a serving cell signal strength, and the serving cell signal strength is above a first predefined threshold value. The apparatus may also include means for triggering reselection based on the increased reselection threshold value.

According to another aspect of the present disclosure, an apparatus for wireless communication includes means for triggering inter-radio access technology (IRAT) cell reselection only when both a signal quality of a serving cell and a signal quality of a neighbor cell are below a threshold value, the neighbor cell and the serving cell being of the same RAT. The apparatus may also include means for communicating according to the reselection.

According to one aspect of the present disclosure, a computer program product for wireless communication in a wireless network includes a computer readable medium having non-transitory program code recorded thereon. The program code includes program code to increase a triggering threshold value for cell reselection when a plurality of neighbor cell signal strengths are each within a predefined range of a serving cell signal strength, and the serving cell signal strength is above a first predefined threshold value.

According to one aspect of the present disclosure, a computer program product for wireless communication in a wireless network includes a computer readable medium having non-transitory program code recorded thereon. The program code includes program code to trigger inter-radio access technology (IRAT) cell reselection only when both a signal quality of a serving cell and a signal quality of a neighbor cell are below a threshold value, the neighbor cell and the serving cell being of the same RAT.

According to one aspect of the present disclosure, an apparatus for wireless communication includes a memory and a processor(s) coupled to the memory. The processor(s) is configured to increase a triggering threshold value for cell reselection when a plurality of neighbor cell signal strengths are each within a predefined range of a serving cell signal strength, and the serving cell signal strength is above a first predefined threshold value.

According to one aspect of the present disclosure, an apparatus for wireless communication includes a memory and a processor(s) coupled to the memory. The processor(s) is configured to trigger inter-radio access technology (IRAT) cell reselection only when both a signal quality of a serving cell and a signal quality of a neighbor cell are below a threshold value, the neighbor cell and the serving cell being of the same RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 illustrates an example TD-SCDMA network according to aspects of the present disclosure.

FIG. 6 is a graphical illustration for cell reselection process based on a non-adaptive trigger value.

FIG. 7 is a graphical illustration for cell reselection process based on an adaptive trigger value.

FIG. 8 is a block diagram illustrating a method for performing IRAT measurement(s) according to one aspect of the present disclosure.

FIG. 9 is a block diagram illustrating a method for adapting a threshold value for triggering cell reselection according to one aspect of the present disclosure.

FIG. 10 is a block diagram illustrating a method for triggering cell reselection according to one aspect of the present disclosure.

FIG. 11 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

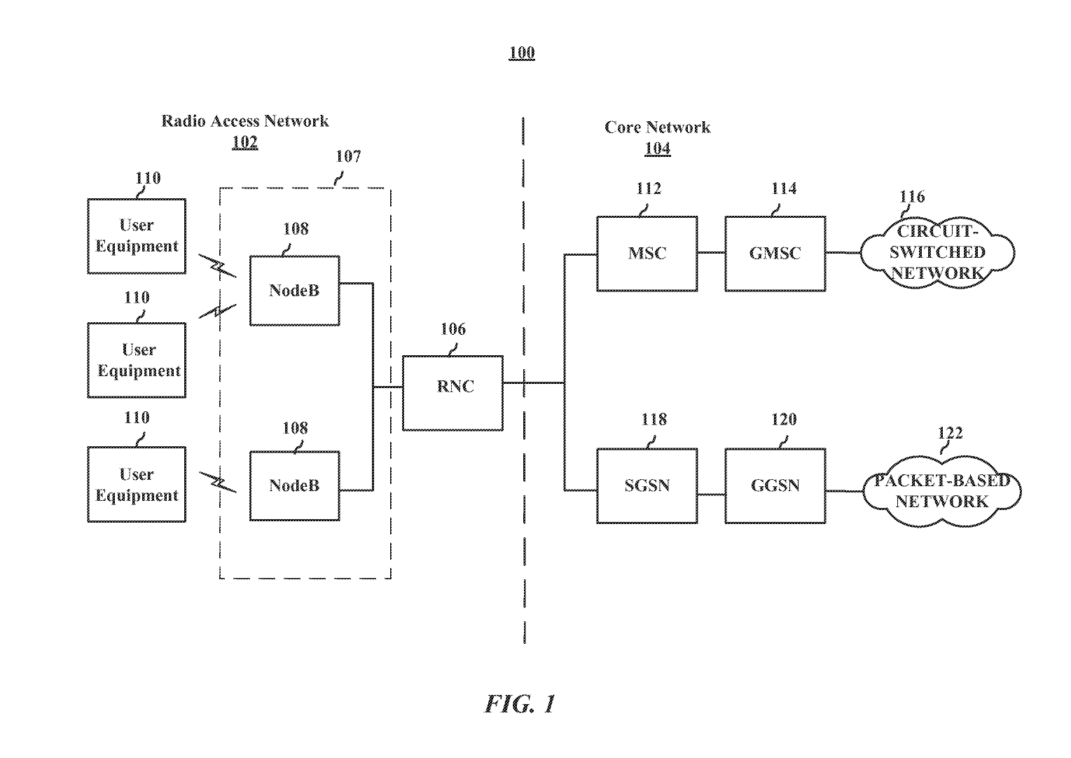

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

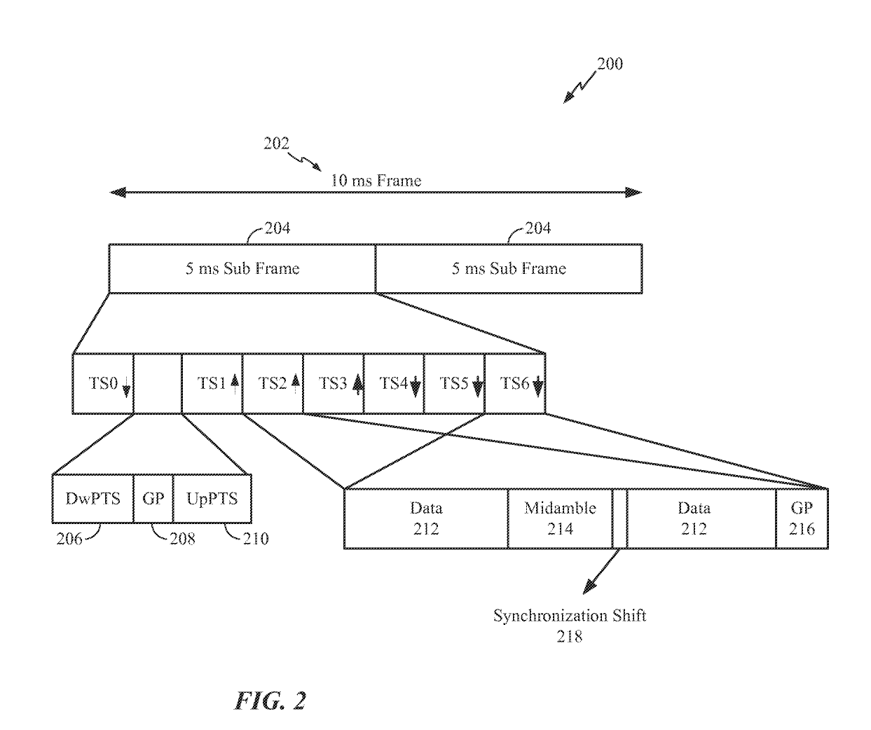

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

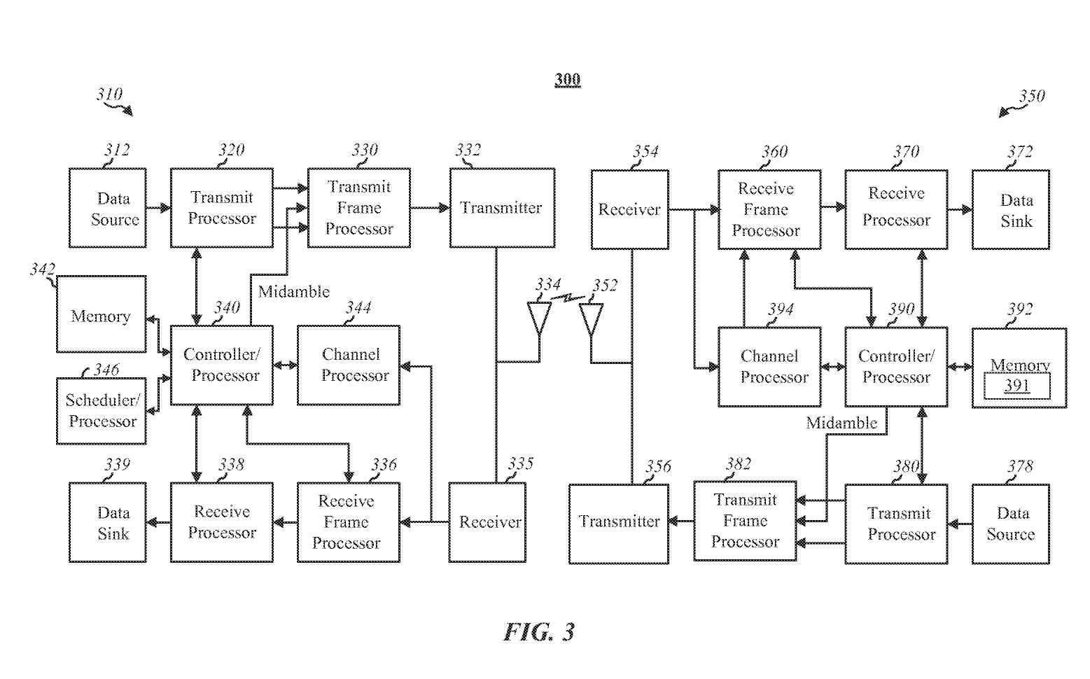

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the UE 350. For example, the controller/processors 390 may provide various functions including timing, peripheral interfaces, voltage regulation, power management, and other control functions. The computer readable media of memory 392 may store data and software for the UE 350. For example, the memory 392 of the UE 350 may store an adaptive threshold value module 391 which, when executed by the controller/processor 390, configures the UE 350 adaptively modifying a threshold value for triggering cell reselection.

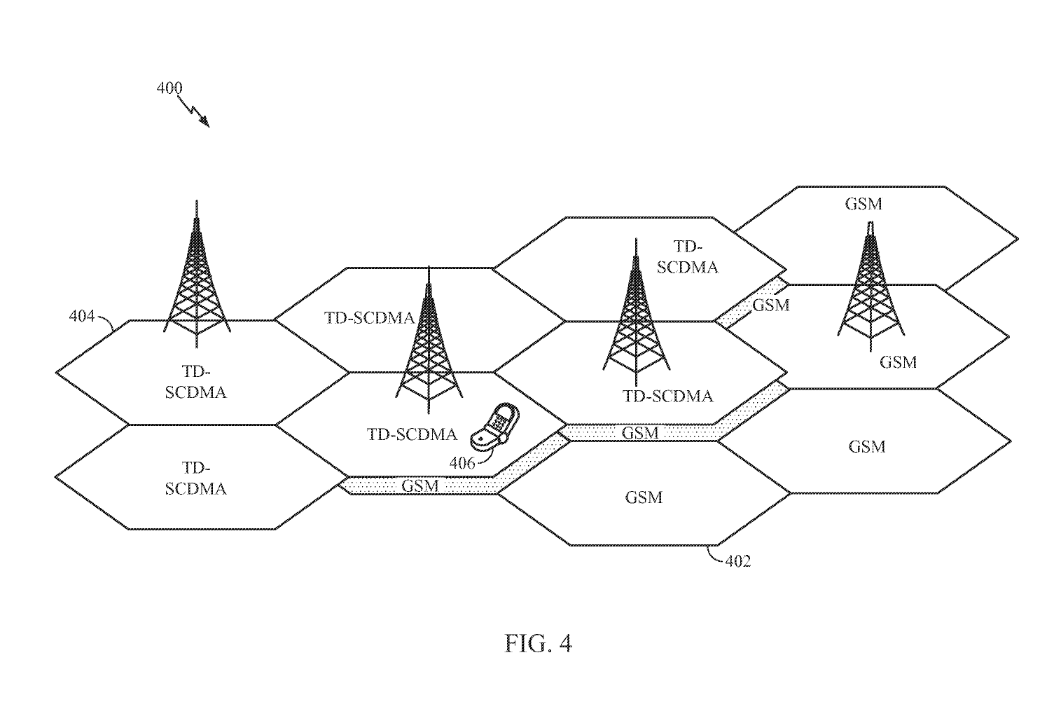

Some networks, such as a newly deployed network, may cover only a portion of a geographical area. Another network, such as an older more established network, may better cover the area, including remaining portions of the geographical area. FIG. 4 illustrates coverage of a newly deployed network, such as a TD-SCDMA network and also coverage of a more established network, such as a GSM network. A geographical area 400 may include GSM cells 402 and TD-SCDMA cells 404. A user equipment (UE) 406 may move from one cell, such as a TD-SCDMA cell 404, to another cell, such as a GSM cell 402. The movement of the UE 406 may specify a handover or a cell reselection.

The handover or cell reselection may be performed when the UE moves from a coverage area of a TD-SCDMA cell to the coverage area of a GSM cell, or vice versa. A handover or cell reselection may also be performed when there is a coverage hole or lack of coverage in the TD-SCDMA network or when there is traffic balancing between the TD-SCDMA and GSM networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The triggering may be based on a comparison between measurements of the different RATs. The measurement may include a TD-SCDMA serving cell signal strength, such as a received signal code power (RSCP) for a pilot channel (e.g., primary common control physical channel (P-CCPCH)). The signal strength is compared to a serving system threshold. The serving system threshold can be indicated to the UE through dedicated radio resource control (RRC) signaling from the network. The measurement may also include a GSM neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

### UE IDLE POWER

In wireless communications systems, a UE operates in a discontinuous reception (DRX) mode to conserve power when it is not in an active call. In the DRX mode, the UE sleeps during the DRX cycle and wakes up to monitor a paging indicator channel/paging channel (PICH/PCH) for page message(s). Thus, the UE idle power is predominantly determined by how often the UE wakes up and the UE wake up duration time. Aspects of the present disclosure are directed to improving UE idle power performance. For example, one aspect is directed to adaptive cell reselection thresholds.

In a wireless communications system, a cell is usually surrounded by close neighbor cells that operate on different frequencies. The UE can receive relatively equal strength radio signals from base stations of some of these neighbor cells.

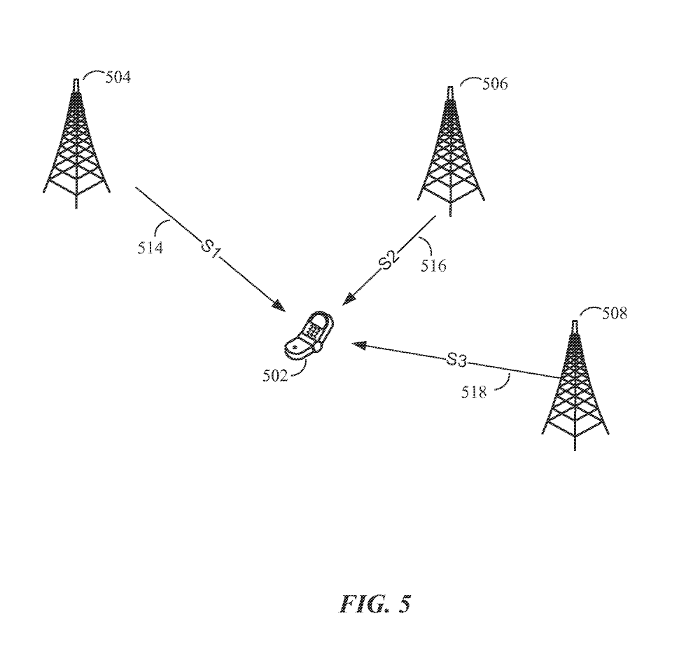

FIG. 5 illustrates an example wireless communications system having multiple base stations 504, 506 and 508, corresponding to neighbor cells and a serving cell. During the DRX cycle, the UE 502 wakes up to check the radio conditions of the various base stations 504, 506, 508. In particular, the UE 502 receives a radio signal 514 from the base station 504 having a signal strength S1. Additionally, the UE receives a radio signal 516 having a signal strength S2 from the base station 506 and a radio signal 518 having a signal strength S3 from the base station 508. Based on the measurements, the UE 502 determines whether to perform cell reselection. Cell reselection is triggered when a signal strength from a current serving cell is a triggering threshold amount below a signal strength from a neighbor cell.

When the UE 502 wakes up again, the radio conditions may have changed. Accordingly, the UE 502 again checks the radio conditions and determines whether to perform cell reselection based on the changed signal strengths. When the signal strengths are relatively similar, the UE 502 may reselect from one cell to another, and then back again. For example, if the signal strength S1 is significantly stronger than the signal strength S2 at one moment but then becomes significantly weaker than the signal strength S2 later, the UE 502 may first reselect to cell or base station 504 and then back again to cell or base station 506. This process is referred to as a ping-pong cell reselection. This may occur, for example, when the signal strengths S1, S2 are relatively similar, i.e., within a predefined range of each other.

When the UE performs cell-reselection, the UE remains awake for a long duration, usually in the range of 300 ms-1.5 s, to perform system information block (SIB) updates. The idle power consumption of the UE increases when the UE remains awake for long durations of time. Thus, ping-pong cell reselection adversely affects battery drain.

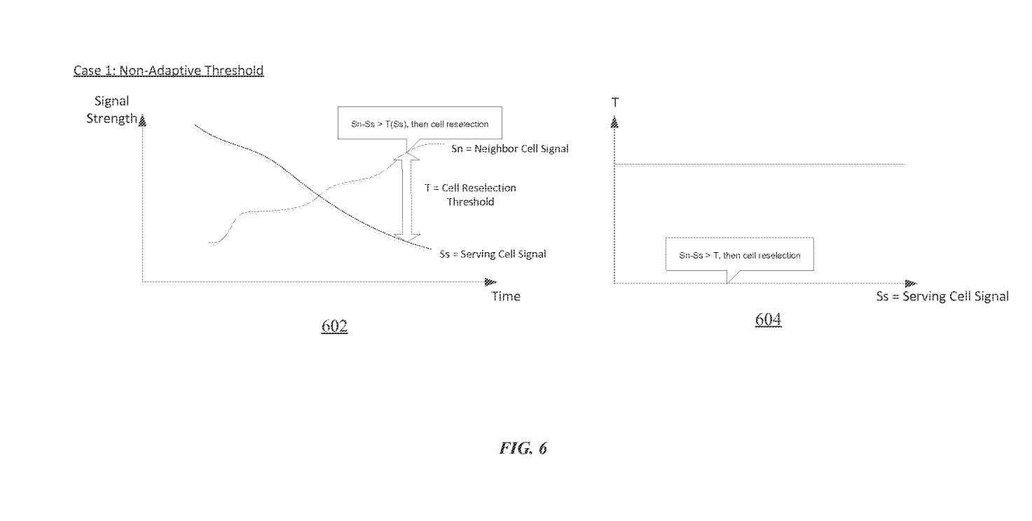

FIG. 6 illustrates a cell reselection process where the reselection triggering threshold value remains constant. In particular, the graph 602 shows the neighbor cell signal strength Sn increasing over time while the serving cell signal strength Ss is decreasing. When the difference in signal strengths between the neighbor cell and serving cell is greater than a predefined, constant threshold, cell reselection is triggered. The graph 604 indicates a constant triggering threshold value T.

To improve UE idle power consumption, one aspect of the present disclosure is directed to an adaptive cell reselection process to help prevent ping-pong cell reselection. The adaptive cell reselection includes adapting the triggering threshold values for reselection based on signal strengths. In one aspect, the triggering threshold value is increased for cell reselection while the UE receives a good signal from a serving cell. When the serving cell signal is poor, the cell reselection triggering threshold value is decreased to allow for fast cell reselection.

Before changing the triggering threshold value, it can be determined whether multiple neighbor signal strengths are all within some range of the serving cell signal strength. If not, the triggering threshold value can be maintained. In another configuration, if only one of the neighbor signal strengths is within the range, the triggering threshold value can change.

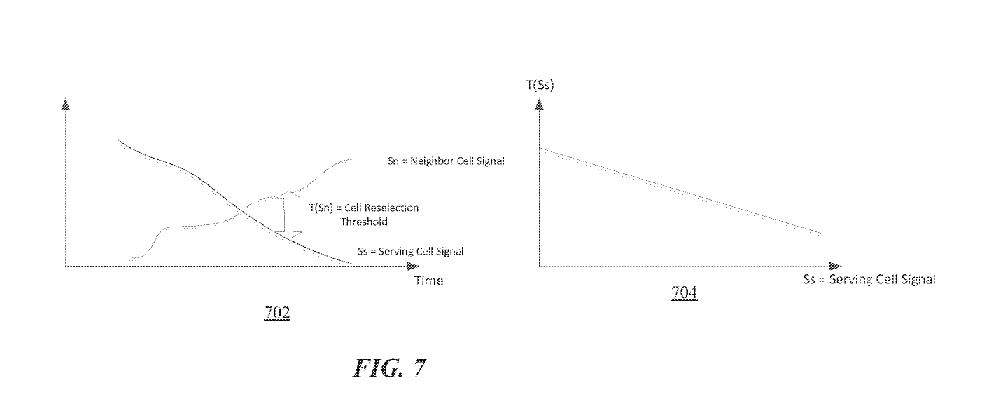

FIG. 7 graphically illustrates an adaptive threshold for triggering a cell reselection process. In particular, the graph 704 illustrates an adaptive reselection triggering threshold value T(Ss) that changes based on the serving cell signal strength Ss. The graph 702 illustrates a neighbor cell signal strength Sn that is increasing over time while the serving cell signal strength Ss is decreasing. Because the serving cell signal strength Ss is decreasing, the triggering threshold T(Ss) also decreases. The cell reselection process is triggered based on the declining serving cell signal quality and thus occurs earlier than it would in the example shown in FIG. 6. In one configuration, the cell reselection is an inter-frequency cell reselection. In another configuration, the cell reselection is an inter-radio access technology (IRAT) cell reselection.

Another aspect of the present disclosure is directed to a smart IRAT cell reselection procedure. TD-SCDMA is a 3G wireless system built on top of the existing GSM 2G system, as shown in FIG. 4. Usually the GSM system has better coverage than the TD-SCDMA system. Thus, a TD-SCDMA cell can have multiple strong GSM neighbor cells.

Performing IRAT GSM measurement(s) can take a significant amount of time as compared to the normal time in TD-SCDMA wake up. For example, it may take about 100 ms to perform a received signal strength indication (RSSI) measurement, as well as frequency correction channel (FCCH) and synchronization channel (SCH) decoding on one GSM cell. In contrast, the TD-SCDMA intra and inter-frequency measurement(s) take much less time. Performing the TD-SCDMA frequency measurements uses a small fraction of time on top of the normal TD-SCDMA wake up for paging indicator channel (PICH) decoding.

In one aspect, the decision of whether to trigger IRAT cell reselection is based on the serving cell radio signal conditions and also the neighbor TD-SCDMA cell radio signal conditions. The UE only reselects to a GSM cell when all the TD-SCDMA cells have poor radio signal conditions. That is, the UE utilizes a combined TD-SCDMA serving cell and neighbor cell radio signal condition to determine whether to trigger IRAT GSM measurement. Triggering based on this combination reduces the frequency of inter radio access technology (IRAT) GSM measurement during the DRX cycle.

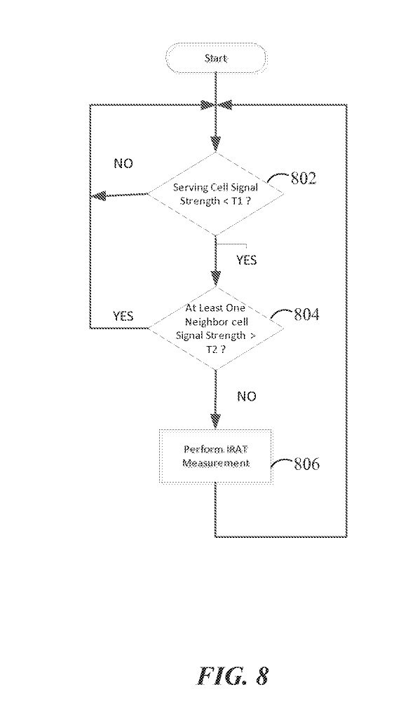

FIG. 8 illustrates a call flow process according to one aspect of the present disclosure. At block 802, the UE considers the TD-SCDMA serving cell signal strength. If the serving cell signal strength is not less than a first threshold value, the UE repeats and continues to evaluate the signal strength. When the TD-SCDMA serving cell signal strength is less than a first threshold value, at block 804 the UE considers a neighbor cell signal strength. If the neighbor cell signal strength is not greater than a second threshold value, then the UE performs an IRAT measurement, at block 806. If the neighbor cell signal strength is greater than the second threshold value, the process returns to block 802. The first and second thresholds can be the same value, or different values, depending on the network configuration.

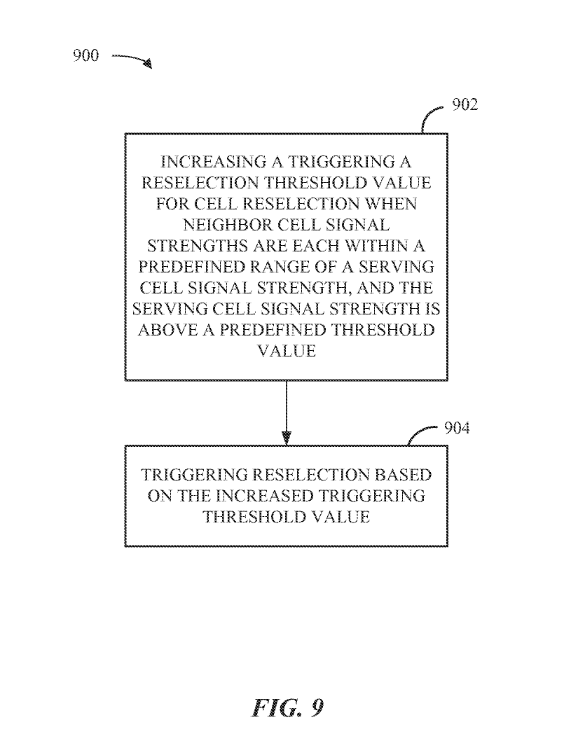

FIG. 9 shows a wireless communication method 900 according to one aspect of the disclosure. In block 902, a UE increases a triggering reselection threshold value for cell reselection when neighbor cell signal strengths are each within a predefined range of a serving cell signal strength, and the serving cell signal strength is above a predefined threshold value. Next, in block 904, reselection is triggered based on the increased reselection threshold value.

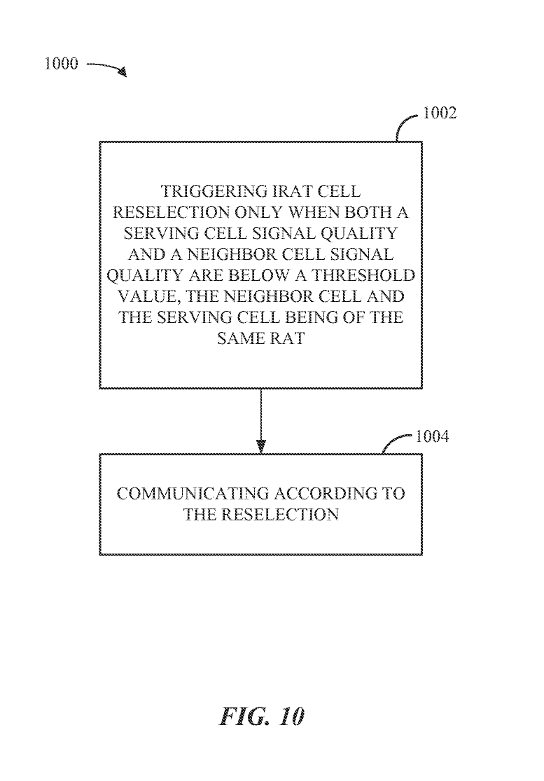

FIG. 10 is a block diagram illustrating a method for triggering cell reselection according to one aspect of the present disclosure. In block 1002, a UE/base station triggers inter-radio access technology (IRAT) cell reselection only when both a serving cell signal quality and a neighbor cell signal quality are below a threshold value. The neighbor cell and the serving cell may be of the same RAT. Next, in block 1004, the UE communicates according to the reselection.

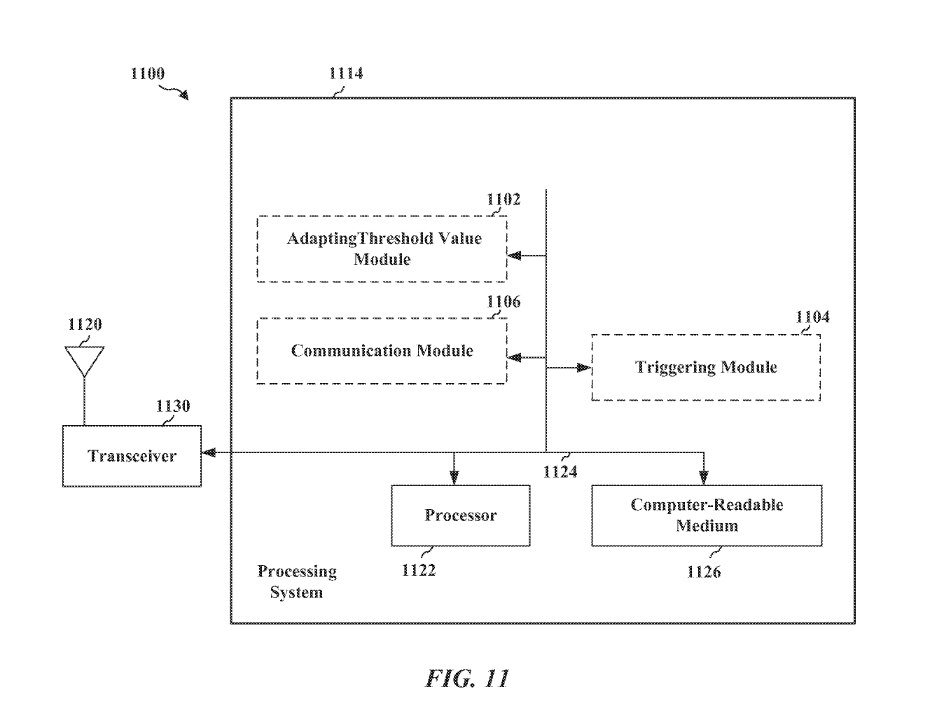

FIG. 11 is a diagram illustrating an example of a hardware implementation for an apparatus 1100 employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1122 the modules 1102, 1104, 1106, and the non-transitory computer-readable medium 1126. The bus 1124 may also link various other circuits such as timing sources, peripherals, voltage regulators, and power management circuits, which are well known in the art, and therefore, will not be described any further.

The apparatus includes a processing system 1114 coupled to a transceiver 1130. The transceiver 1130 is coupled to one or more antennas 1120. The transceiver 1130 enables communicating with various other apparatus over a transmission medium. The processing system 1114 includes a processor 1122 coupled to a non-transitory computer-readable medium 1126. The processor 1122 is responsible for general processing, including the execution of software stored on the computer-readable medium 1126. The software, when executed by the processor 1122, causes the processing system 1114 to perform the various functions described for any particular apparatus. The computer-readable medium 1126 may also be used for storing data that is manipulated by the processor 1122 when executing software.

The processing system 1114 includes an adapting threshold value module 1102 for changing a triggering reselection threshold value. The processing system 1114 also includes a triggering module 1104 for triggering reselection. The processing system 1114 also includes a communicating module 1106 for communicating according to the reselection. The modules may be software modules running in the processor 1122, resident/stored in the computer readable medium 1126, one or more hardware modules coupled to the processor 1122, or some combination thereof. The processing system 1114 may be a component of the UE 350 and may include the memory 392, the adaptive threshold value_module 391, and/or the controller/processor 390.

In one configuration, an apparatus such as a UE is configured for wireless communication including means for increasing a threshold value. In one aspect, the increasing means may be the controller/processor 390/1122, adapting threshold value module 1102, and/or the memory 392 configured to perform the increasing. The UE is also configured to include means for triggering. In one aspect, the triggering means may be the controller/processor 390/1122, the triggering module 1104, and/or the memory 392, configured to perform the triggering. The UE is also configured to include means for communicating. In one aspect, the communicating means may be the controller/processor 390/1122, the communicating module 1106, the transceiver 1130, the antenna 1120/352, the transmitter 356, the receiver 354, and/or the memory 392, configured to perform the communicating. In one aspect, the aforementioned means may be any module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
increasing a triggering threshold value for cell reselection when a plurality of neighbor cell signal strengths are each within a predefined range of a serving cell signal strength, and the serving cell signal strength is above a first predefined threshold value.

2. The method of claim 1, further comprising decreasing the triggering threshold value when the serving cell signal strength is below a second predefined threshold value.

3. The method of claim 1, further comprising decreasing the triggering threshold value when only one of the plurality of neighbor cell signal strengths remains within the predefined range of the serving cell signal strength.

4. The method of claim 1, in which the triggering threshold value comprises an inter-frequency triggering threshold value.

5. The method of claim 1, in which the triggering threshold value comprises an inter-radio access technology (IRAT) triggering threshold value.

6. A method of wireless communication, comprising:
triggering inter-radio access technology (IRAT) cell reselection only when both a signal quality of a serving cell and a signal quality of a neighbor cell are below a threshold value, the neighbor cell and the serving cell being of the same RAT.

7. An apparatus for wireless communication, comprising:
means for increasing a triggering threshold value for cell reselection when a plurality of neighbor cell signal strengths are each within a predefined range of a serving cell signal strength, and the serving cell signal strength is above a first predefined threshold value; and
means for triggering reselection based on the increased triggering threshold value.

8. The apparatus of claim 7, further comprising means for decreasing the triggering threshold value when the serving cell signal strength is below a second predefined threshold value.

9. The apparatus of claim 7, further comprising means for decreasing the triggering threshold value when only one of the plurality of neighbor cell signal strengths remains within the predefined range of the serving cell signal strength.

10. An apparatus for wireless communication, comprising:
means for triggering inter-radio access technology (IRAT) cell reselection only when both a signal quality of a serving cell and a signal quality of a neighbor cell are below a threshold value, the neighbor cell and the serving cell being of the same RAT; and
means for communicating according to the reselection.

11. An apparatus for wireless communication, comprising:
a memory; and
at least one processor coupled to the memory and configured:
to increase a triggering threshold value for cell reselection when a plurality of neighbor cell signal strengths are each within a predefined range of a serving cell signal strength, and the serving cell signal strength is above a first predefined threshold value.

12. The apparatus of claim 11, in which the at least one processor is further configured to decrease the triggering threshold value when the serving cell signal strength is below a second predefined threshold value.

13. The apparatus of claim 11, in which the at least one processor is further configured to decrease the triggering threshold value when only one of the plurality of neighbor cell signal strengths remains within the predefined range of the serving cell signal strength.

14. The apparatus of claim 11, in which the triggering threshold value comprises an inter-frequency triggering threshold value.

15. The apparatus of claim 11, in which the triggering threshold value comprises an inter-radio access technology (IRAT) triggering threshold value.

16. An apparatus for wireless communication, comprising:
a memory; and
at least one processor coupled to the memory and configured:
to trigger inter-radio access technology (IRAT) cell reselection only when both a signal quality of a serving cell and a signal quality of a neighbor cell are below a threshold value, the neighbor cell and the serving cell being of the same RAT.

17. A computer program product for wireless communications in a wireless network, comprising:
a computer-readable medium having non-transitory program code recorded thereon, the program code comprising:
program code to increase a triggering threshold value for cell reselection when a plurality of neighbor cell signal strengths are each within a predefined range of a serving cell signal strength, and the serving cell signal strength is above a first predefined threshold value.

18. The computer program product of claim 17, in which the program code further comprises code to decrease the triggering threshold value when the serving cell signal strength is below a second predefined threshold value.

19. The computer program product of claim 17, in which the program code further comprises code to decrease the triggering threshold value when only one of the plurality of neighbor cell signal strengths remains within the predefined range of the serving cell signal strength.

20. A computer program product for wireless communications in a wireless network, comprising:
a computer-readable medium having non-transitory program code recorded thereon, the program code comprising:
program code to trigger inter-radio access technology (IRAT) cell reselection only when both a signal quality of a serving cell and a signal quality of a neighbor cell are below a threshold value, the neighbor cell and the serving cell being of the same RAT.
